(19) United States
(12) Patent Application Publication
(10) Pub. No.: US 2026/0241819 A1
(43) Pub. Date: Aug. 20, 2026

(54) Charging Station for E-Scooters

(71) Applicant: ONgineer GmbH, Espellkamp (DE)

(72) Inventors: Andre Müller, Rahden (DE); Claus-Martin Mündel, Lübbecke (DE); Stefan Honerkamp, Bad Essen (DE)

(21) Appl. No.: 19/144,283

(22) PCT Filed: Dec. 28, 2023
(86) PCT No.: PCT/EP2023/087911

§ 371 Date: Jun. 27, 2025

(30) Foreign Application Priority Data
Dec. 28, 2022 (DE) 10 2022 134 944.6

(51) Int. Cl. B60L 53/31; B60L 53/12; B60L 53/51; B60L 53/53; B60L 53/66; B60L 53/67

(52) U.S. Cl. CPC B60L 53/31; B60L 53/12; B60L 53/51; B60L 53/53; B60L 53/665; B60L 53/67; B60L 2200/12; B60L 2240/622; B60L 2270/36

(57) ABSTRACT

English translation of originally filed PCT application The invention relates to a system comprising a battery-powered vehicle (1), in particular an e-scooter, which has a fixing device (17), a battery, a charging connection (16), a plurality of wheels (11, 12), and a track width of less than 50 cm. Furthermore, the system comprises a station (2) for charging and holding the vehicle (1). The station (2) comprises: a fixing means (27), that corresponds to the fixing device (17), for fixing the vehicle (1) in a fixing state of the system; and a charging device. In the fixing state, the fixing means (27) and the fixing device (17) engage with one another, preventing the vehicle (1) from being removed from the station (2), and, in a release state of the system, the fixing means (27) and the fixing device (17) do not engage with each other, allowing the vehicle (1) to be removed from the station (2).

The invention relates to a system comprising at least one, in particular several, battery-powered vehicle(s) and a station for charging and holding the vehicle according to the generic part of claim 1 as well as to a system which comprises at least one battery-powered vehicle and at least one station, and to a method for keeping a battery-driven vehicle available at a station.

Light battery-powered vehicles (LEVs or light electric vehicles) are increasingly being used, especially in the public domain and above all in big cities. Such vehicles enable fast progress in traffic, can be easily parked and, in addition, do not emit any pollutants during use. Such a vehicle, to which a generic system relates, has at least one front wheel and one rear wheel. There are also known vehicles in which a pair of front wheels and/or a pair of rear wheels are provided, in which case such a pair of front wheels or rear wheels rotates spatially about a same axis of rotation. The invention particularly refers to vehicles with small track width, for example vehicles with only one front wheel or only one rear wheel, or to vehicles in which a pair of front wheels and/or a pair of rear wheels are provided, in which case the wheels of the pair are only slightly spaced from each other, in particular by less than 50 cm, in particular by less than 40 cm and even more in particular by less than 30 cm. Such a vehicle preferably has a track width of less than 50 cm, wherein the track width is defined as the extension length along an axis of rotation between the ends of at least one wheel pointing away from each other with respect to this axis of rotation, in particular the pair of wheels provided on the axis of rotation, which pair of wheels is or are designed for rotation about the axis of rotation. Thus, the track width on an axis of rotation on which only one wheel is provided is defined by the width of the wheel. In most cases, battery-powered vehicles to which the present invention relates are two-wheeled vehicles, but there are also known vehicles in which a pair of wheels with a smaller track width are provided on one axis of rotation in order to ensure greater driving stability. In particular, the present invention relates to e-scooters as a battery-powered vehicle or as battery-powered vehicles of the system.

In the systems of the specified type, there are two fundamental problems: the battery-powered vehicles must be charged regularly on the one hand. This poses a particular problem because the vehicles should naturally be as lightweight as possible, for which reason the battery capacity is limited. On the other hand, it must be possible to park the vehicles as secure as possible against theft. Especially in systems in which a great number of vehicles are used, for example several hundreds of vehicles, it must also be ensured that they are distributed as expediently as possible and/or parked in way that causes as little interference as possible. Conventional systems meet these requirements only insufficiently. Stations which are known in the prior art are expensive to implement, occupy considerable space and are difficult to operate. For this reason, known stations are not used very frequently, but the battery-powered vehicles are instead charged and secured individually. For an individual owner of such a vehicle, this means a lot of work, and for operators of vehicle fleets with a large number of vehicles, especially several hundred vehicles, the effort is considerable, as the vehicles have to be charged individually by staff and distributed in a targeted manner by staff, and are often subject to vandalism due to a lack of security. DE 10 2020 109 573 A1 discloses a system with multiple stations and multiple vehicles, as well as a method wherein deposit charge information and deposit credit information are processed depending on whether a vehicle has been parked away from the stations, has been parked at any station, or has been parked at a specific station belonging to a group of designated stations.

The present invention is based on the problem of providing a system or method which can remove at least one disadvantage of existing systems or methods, at least partially.

As a solution to the problem underlying the present invention, the invention proposes a system with the features according to claim 1. The system comprises a battery-driven vehicle. The vehicle comprises a fixing device, a battery, a charging port and several wheels. Preferably, the vehicle has a track width of less than 50 cm. The system further comprises a station for charging and holding the vehicle. The station comprises a fixing means corresponding to the fixing device of the vehicle, wherein the fixing device and the fixing means are designed to correspond to each other in such a way that, in a fixing state of the system, the vehicle is fixed at the station by the interaction of the fixing device and the fixing means. The fixing state of the system describes a defined arrangement of the components of the system to each other. Preferably, in the fixing state, the charging port of the vehicle is connected to a charging device of the station, so that the charging device charges the vehicle by means of the charging port. Connection of the charging port to the charging device is generally possible via a cable or wireless. Preferably, the station further comprises an inductive charging device for inductive charging of the battery of the vehicle in the fixing state by means of the charging port of the vehicle. Accordingly, the charging port of the vehicle can be designed to enable inductive charging of the battery, whereby wireless charging is ensured. Preferably, for this purpose, the charging port is electrically connected to the battery and forms an interface via which it can receive energy from an inductive charging device. Typically, an inductive charging device comprises at least one, in particular more, primary coils, and the charging port comprises one, in particular more, secondary coils. Supplying the primary coil with energy generates an electromagnetic field which generates a current flow in the secondary coil which is routed from the charging port to the battery in the vehicle for charging the battery. Preferably, the fixing means and the charging device of a station are fixed in position relative to each other. It is also preferred for the fixing device and the charging port of the vehicle to be fixed in position relative to each other. Preferably, by the fixed positioning of the fixing means and the fixing device to each other in the fixing state, the charging port is fixed in position relative to the charging device. In the fixing state of the system, the fixing means and the fixing device engage with one another, in which case the interlocking of the fixing means and the fixing device prevent the vehicle from being removed from the station. Accordingly, the interlocking of the fixing means and the fixing device serves the purpose of securing the vehicle at the station to prevent vandalism or unauthorized use of a vehicle. In a release state of the system, the fixing device and the fixing means are disengaged from each other, so that the vehicle is not fixedly positioned at the station by this interaction, but can be or is detached or removed from the station. The interlocking of the fixing means and the fixing device in the fixing state serves to position the charging port relative to the charging means in a targeted manner to ensure that the battery of the vehicle can be charged in the fixing state. The system according to the invention therefore offers the particular advantage of ensuring both the securing and efficient charging of the vehicle at the station in a simple manner, so that the vehicle is kept ready for use by a user at the station. The system is particularly simple in design. Preferably, one of the fixing device and fixing means has a first fixing section designed in the manner of a movable bolt and a locking device for moving the first fixing section. The other of the fixing device and fixing means has a second fixing section which is designed as a receptacle for the first fixing section. Preferably, in the fixing state, the first fixing section is arranged in the receptacle and is enclosed by the receptacle preventing the first fixing section from being removed from the receptacle. Preferably, in this manner, detaching the vehicle from the station is preferably prevented by the arrangement of the first fixing section in the second fixing section, i.e. in the receptacle, in the fixing state. Preferably, enclosing the first fixing section in the receptacle means engaging around the first fixing section, at least partially, wherein this engaging ensures that the first fixing section cannot be moved out of the receptacle. In one embodiment, the receptacle in the fixing state encloses the first fixing section in each of the three mutually perpendicular spatial directions on both sides. In another embodiment, the receptacle encloses the first fixing section in at least one spatial direction on only one side, wherein a further section of the fixing device and fixing means ensures that the vehicle cannot be removed from the station even in the direction facing the other side along the spatial direction. For example, the receptacle may be U-shaped, with the U open at the bottom and the bolt located inside the U in the fixing state, wherein in the fixing state, the vehicle rests with its underside against a section of the fixing means so that it is impossible for the bolt to move downwards out of the U in the fixing state. Preferably, the first fixing section can be moved out of the receptacle from the fixing state by means of the locking device in order to achieve a release state of the system in which the vehicle can be removed from the station. The movability of the bolt by means of the locking device thus allows the position of the bolt to determine whether the system is in the locked state or in the released state. The bolt can have a suitable shape for this purpose, for example, it can be designed as a cylindrical bolt or as a curved bolt. It is essential that the position of the bolt fixed in the locking state prevents the bolt from being removed from the receptacle by the interaction of the fixing device and the fixing means, whereas in the position of the bolt in the release state, the interaction of the fixing device and the fixing means does not prevent the vehicle from moving relative to the station.

In advantageous embodiments, the invention can thus offer the particular advantage of combining two simplifying measures: on the one hand, a particularly simple measure is provided for securely fixing a vehicle to a station. On the other hand, a particularly simple measure is provided for charging the vehicle. The combination of these measures ensures that the interaction of the fixing device and the fixing means alone aligns the vehicle relative to the station in such a way that inductive charging is possible. The system according to the invention is particularly easy to operate by a user of the vehicle, since the user only has to park the vehicle at a station in such a way that the locking device can move the bolt so that the system can assume the fixing state starting from the release state in which it is initially when a user parks the vehicle at the station. The interlocking of the fixing device and the fixing means then ensures both that the vehicle is securely fixed in place to prevent vandalism or unauthorized use and that an efficient charging process can be carried out, since the vehicle is held with its charging port directly in a position that allows charging to take place, wherein, due to the provision of an inductive coupling between the charging port and the charging device, an electrically conductive connection between these by means of corresponding electrically conductive contacts is not required or can be avoided, so that the very simple fixing of the vehicle at the station is not accompanied by a load on the contacts required for charging. In this case, the fixing device and the fixing means alone, independently of the electromagnetic connection between the charging port and the charging device required to carry out the charging process, ensure that the vehicle is positioned and fixed in a defined position at the station in the fixing state. Accordingly, in advantageous embodiments, the system of the invention offers new possibilities for use of battery-powered vehicles in public spaces. The simple design of the fixing means and the fixing device allow the station to be small in size, and by automatically holding the charging port in a predefined position relative to the charging device when the system is in the fixing state, a charging process can be carried out automatically and wear at system components can be largely reduced. Due to the simplicity of the system, it can be equipped with interfaces or a control device of such a kind that large numbers of vehicles can be easily kept ready at stations in an automated manner. For example, the control device of the system can be designed to recognize the need for a charging process when a vehicle is in a fixing state of the system at a station and, if a need is detected, automatically initiate or carry out a charging process. Furthermore, user authentication can be enabled via the interfaces. In addition, depending on the user's preference, the station can either fix a vehicle in place or also charge the vehicle. For example, different profiles can be stored in the control device so that a single station can meet different customer requirements, which is not only environmentally friendly but also makes sense from a cost and space saving perspective. Some users can use the station purely for securing their vehicle, while other users can also charge their vehicles, so that, depending on the profile used, such a station can be used simultaneously by a fleet operator and by private individuals with their private vehicles, provided that a sufficient number of charging devices and fixing means are provided at this station to fix or charge a sufficient number of vehicles at the station. In general, the invention preferably relates to a system with a station that has several charging devices and several fixing means. Each charging device is designed to correspond to a charging port on a vehicle. Each fixing means is designed to correspond to a fixing device on a vehicle. The station can be designed to accommodate the same vehicle at different locations, i.e. the same vehicle can be securely fixed at several of the station's fixing means and charged at a charging device corresponding to the respective fixing means. All charging devices of a station can be designed completely individually from one another or, alternatively, can at least partially use a common infrastructure, for example a central controller and/or a common central supply connection of the station.

It is particularly preferred that the fixing device and the fixing means engage one another in the fixing state in such a way that their relative position to each other is fixed in all three spatial directions. This ensures that the vehicle is held particularly securely in the fixing position at the station. Particularly preferably, the relative position of the first fixing section relative to the second fixing section, i.e. relative to the receptacle, is fixed in at least one spatial direction and, in particular, fixed in one direction along a further spatial direction, through the arrangement of the first fixing section in the receptacle, whereas in the other direction along this further spatial direction, the relative position is fixed by a further section of the fixing means and a further section of the fixing device, which are designed to correspond to each other. In the present case, the three spatial directions refer to the three spatial directions perpendicular to each other, which span a three-dimensional space. In general, it is preferred that the relative position of the fixing means and the fixing device to each other in the fixing state is defined by the interlocking of the fixing means and the fixing device to at least a position range of less than 5 cm, in particular less than 3 cm, in particular less than 2 cm, in particular less than 1 cm in all three spatial directions. Thus, in the fixing state, the fixing device and the fixing means can move relative to each other along all three spatial directions by at most 5 cm, in particular at most 3 cm, in particular at most 2 cm, in particular at most 1 cm. It is particularly preferred that, due to the interlocking of the fixing device and the fixing means in the fixing state, their relative position to each other along at least one of the spatial directions, in particular along at least two of the spatial directions, is fixed to a position range of less than 2 cm, in particular less than 1 cm, assigned to the respective spatial direction. By defining the position of the fixing means and the fixing device relative to each other, the position of the charging device and the charging port relative to each other can be defined accordingly, so that this definition ensures that the battery can be charged with a high degree of efficiency in the fixing state through the interaction of the charging device and the charging port. It has proven particularly advantageous to set the position range in a specific spatial direction, within which the fixing means and the fixing device can move relative to each other in the fixing state, smaller than in at least one other spatial direction, in particular than in both other spatial directions. This makes it as easy as possible for a user to park and connect the vehicle at the station, while at the same time ensuring high-efficiency charging. It has proven particularly advantageous to fix the relative position of the fixing device and the fixing means to one another by means of their interlocking so that they can be moved to each other along a first spatial direction by at least 1 cm, in particular at least 1.5 cm, in particular at least 2 cm, from each other, whereas their relative position with respect to a second spatial direction is fixed to a position range of less than 2 cm, in particular less than 1.5 cm, in particular less than 1 cm, in particular less than 0.7 cm. This ensures a certain degree of variability in the first spatial direction and thus easy connection of the vehicle to the station, whereas with respect to the second spatial direction, the vehicle can be fixed as precisely as possible to the station and thus also the charging port relative to the charging device. The charging device preferably has a primary coil and the charging port has a secondary coil, each of which is assigned a coil axis, wherein the second spatial direction forms an angle of less than 30°, in particular an angle of less than 20° to the coil axes of the primary and secondary coils, wherein, in particular, the second spatial direction runs parallel to the coil axis of the secondary coil and the remaining spatial directions are perpendicular to this second spatial direction. Thus, by defining the second spatial direction, it is possible to arrange the primary and secondary coils very close to each other, which is beneficial for high efficiency when charging the battery. Preferably, the characteristics described above for the second spatial direction apply in general to the specific spatial direction described above.

In particular, the invention is dedicated to solving the problem of inefficient spatial distribution of vehicles. In practice, it has been shown that conventional systems often experience asymmetrical or inefficient spatial distribution of vehicles during their operating time, which means, among other things, that few or no vehicles are available at individual stations. For example, there are often not enough vehicles available at busy locations. Vehicles are often parked so far away from stations that charging and thus further use of the vehicle is only possible with considerable effort. Such problems can have a significant negative impact on the overall user satisfaction of users of these systems, resulting in lower sales. Furthermore, vehicles, especially large groups of vehicles, are often parked in such a way that they obstruct footpaths and cycle paths.

To solve the aforementioned problem of uneven spatial distribution of vehicles, the invention proposes an embodiment of the system according to the invention, which is characterized in that the vehicle comprises a drive, in particular in the form of an electric motor, which is designed to drive the vehicle, and a communication interface, in particular a wireless communication interface such as NFC, Bluetooth, NB-IoT, Wi-Fi, ZigBee, or other radio interfaces. In an enable state of the vehicle, the drive can be controlled, and in a disable state of the vehicle, control of the vehicle is prevented, in particular, the power supply to the drive is interrupted in the disable state. The vehicle may have a disable device that can be switched to a disable state and to a enable state, whereby the vehicle can be switched to its disable state or enable state. According to the invention, a change between the disable state and the enable state of the vehicle can be made both in the release state and in the fixing state. The system, in particular the vehicle and/or the station and/or a central unit connected to the vehicle and/or the station, comprises a computing device, in particular a microcontroller and/or a processor unit, and a memory, in particular a RAM memory and/or a non-volatile memory such as an HDD. The central unit with computing device can be provided as the central computing unit described here in connection with embodiments. The computing device is designed to communicate with the communication interface of the vehicle, and the computing device is further designed to store a predefined value in a memory area of the memory upon detection of a transition of the vehicle from the fixing state to a ready-to-drive state in which it has the release state and the enable state, and to convert this predefined value into a first modified value when the vehicle transitions from the ready-to-drive state to the disable state, and/or to convert the predefined value into a second modified value when the vehicle transitions from the ready-to-drive state to a state in which it is in the disable state and, in addition, in the fixing state. The system comprises a plurality of further vehicles. The further vehicles may, in particular, also have the features described here for one vehicle. In particular, a central unit with a computing device may be provided which can communicate with the respective vehicle via the communication interface of each respective vehicle as explained above. This embodiment allows different state transitions in the system to be detected and mapped differently in the corresponding modified values, whereby it is possible to react flexibly to various variable parameters of the system. In particular, the detection of a state may comprise the determination by the computing device, via sensors such as infrared sensors, pressure sensors or push buttons, that the vehicle is in a certain state, e.g. that power supply to the battery is interrupted or that the vehicle is fixed at a station.

According to the invention, the computing device is designed to receive user data, such as a user account in a cloud, account data, or bank data, for use with the vehicle. Furthermore, in one embodiment, the computing device is designed to assign the first modified value in the memory area to the received user data storing a first credit balance information assigned to the user data in the memory. In addition, the computing device is designed in one embodiment to assign the second modified value in the memory area to the received user data storing a second credit balance information assigned to the user data in the memory. The computing device is designed to assign credit information to the user account in the memory upon detection of a transition of the vehicle from the ready-to-drive state to only the disable state, depending on the first credit balance information, wherein the dependency of the credit information on the first credit balance information is determined by a first dependency function. Furthermore, the computing device is designed to, when detecting a transition of the vehicle from the ready-to-drive state to the state in which it has the fixing state and the disable state, assign credit information to the user account in the memory depending on the second credit balance information, wherein the dependency of the credit information on the second credit balance information is determined by a second dependency function. Such a preferred embodiment makes it possible to influence the credit information by recognizing the different states of the vehicle and by modifying the credit balance information accordingly using the dependency functions, and to reactively change the credit information with regard to the different cases of state transitions. For example, by coordinating the two dependency functions, it is possible to achieve that one of the state transitions results in positive credit information, whereby any users of the vehicle will prefer to carry out this state transition with the vehicle. By introducing the dependency functions, it is thus possible to modify the credit information not only as dependencies of the state transitions, but also to modify the credit information for a specific state transition. Preferably, each of the dependency functions has a parameter that depends on a location of the vehicle on Earth (identified for example by GPS coordinates) and a parameter that depends on time. To define the dependency on time, the time can be defined by a date and a time on the respective date. Preferably, each dependency function thus has a dependency on the location of the vehicle and on time. This makes it particularly easy to take into account location-and time-dependent specifications for the appropriate spatial distribution of the vehicles. According to the invention, the system comprises several stations, in which case the vehicle can be brought into the fixing state at each station.

In one embodiment, the computing device is designed to define an area defined by a first perimeter around a first geoposition as the target parking location, wherein the first perimeter is defined by a first perimeter definition. Preferably, the first perimeter definition is determined, in particular by the computing device, depending on a first predefined density of vehicles in a predefined perimeter of the geoposition. It is particularly preferred that the first dependency function includes, as a parameter influencing a value of the first dependency function, the query whether a transition from the ready-to-drive state to the disable state has been detected at the target parking location. Furthermore, it is particularly preferred that the first perimeter definition is determined depending on time data, position data, weather data, and/or that the computing device is designed to determine the first perimeter definition depending on user input data received at the computing device. The term geoposition essentially means a position defined by longitude and latitude, which can be determined or specified by GPS, for example. Surprisingly, this embodiment has proven to be particularly useful for achieving a desired spatial distribution of vehicles by allowing the system to react to external influences and/or defined influences and by offering a financial incentive, e.g. through credit payments, to park vehicles at target stations and/or target parking locations. The inventors have recognized that defining a target parking location by means of a perimeter, which is itself defined by a perimeter definition that depends on physical characteristics of the system, for example the density of vehicles, the availability of fixing devices at the station and/or other data entered by a user, allows the credit balance information to be set in a particularly targeted manner to achieve a desired spatial distribution of the vehicles. In a further preferred embodiment, the computing device is designed to define the station or one of the multiple stations located within a second perimeter around a second geoposition as the target station, wherein the second perimeter is set by a second perimeter definition. Preferably, the second perimeter definition is determined, in particular by the computing device, depending on a second predefined density of vehicles in a predefined perimeter of the second geoposition. Furthermore, the second dependency function preferably includes, as a parameter influencing a value of the second dependency function, the query whether a detection of the transition from the ready-to-drive state to the state in which the vehicle is in the fixing state and disable state, has occurred at the station defined as the target station, and/or the second dependency function includes, as a parameter influencing a value of the second dependency function, the query whether a transition from the ready-to-drive state to the disable state has been detected in the predefined second perimeter around the target station. Preferably, the second dependency function depends on a detection of availability of the target station, such as a complete occupancy of the target station and/or the detection of a defect of the target station. Furthermore, it is preferred that the second perimeter definition is determined depending on time data, position data, weather data, and/or that the computing device is designed to determine the first perimeter definition depending on user inputs received at the computing device. In general, the first dependency function and the second dependency function and in particular the first perimeter definition and the second perimeter definition, differ in their functional dependencies. Furthermore, the aforementioned problem of uneven spatial distribution of vehicles is solved by a method according to the invention for operating a system according to the invention, wherein the system comprises a battery-powered vehicle, in particular an e-scooter, which has a fixing device, a battery, a charging port, several wheels, and a track width of less than 50 cm, as well as a station for charging and holding the vehicle, wherein the station comprises a fixing device corresponding to the fixing means for fixing the vehicle in a fixing state of the system and a charging device. In the fixing state, the fixing means and the fixing device engage one another, preventing the vehicle from being removed from the station, wherein in a released state of the system, the fixing means and the fixing device do not engage with each other, so that the vehicle can be removed from the station. The vehicle further comprises a drive and a communication interface, in particular a wireless communication interface such as NFC, Bluetooth, NB-IoT, Wi-Fi, ZigBee or other radio interfaces, wherein in an enable state of the vehicle, the drive can be controlled and in a disable state of the vehicle, control of the drive is prevented. The method is characterized in that monitoring takes place as to whether the vehicle transitions from the fixing state to a ready-to-drive state in which it is in the release state and the enable state and, upon detection of such a transition, a predefined value is stored, and thereafter monitoring takes place as to whether the vehicle transitions from the ready-to-drive state to merely the disable state without also transitioning to the fixing state, or whether it transitions from the ready-to-drive state to both the disable state and the fixing state. Upon detection of a transition of the vehicle from the ready-to-drive state to merely the disable state, the predefined value is converted into a first modified value and/or the predefined value is converted into a second modified value upon a transition of the vehicle from the ready-to-drive state to the disable state and the fixing state, the system comprising a plurality of further vehicles which are monitored with regard to their status and their location. User data is received for use of the vehicle, wherein, depending on whether the predefined value has been converted, the first modified value is assigned to this user data while storing a first credit information assigned to the user data or alternatively the second modified value is assigned to this user data while storing a second credit information assigned to the user data where, upon detection of a transition of the vehicle from the ready-to-drive state to the disable state, a credit information is assigned to the user account depending on the first credit balance information, wherein the dependency of the credit information on the first credit balance information is determined by a first dependency function and wherein upon detection of a transition of the vehicle from the ready-to-drive state to the state in which it has the fixing state and the disable state, a credit information is assigned to the user account depending on the second credit balance information, wherein the dependency of the credit information on the second credit balance information is determined by a second dependency information, wherein an area defined by a first perimeter around a first geoposition is defined as the target parking location, wherein the first perimeter is defined by a first perimeter definition, wherein the first dependency function includes, as a parameter influencing a value of the first dependency function, the query whether a transition from the ready-to-drive state to the disable state has been detected at the target parking location.

In one embodiment, that one of the first or second fixing section which is comprised by the fixing device is provided at a front of the vehicle. In general, it should be noted at this point that either the vehicle forms the first fixing section and the station forms the second fixing section, or the station forms the first fixing section and the vehicle forms the second fixing section. By providing the fixing section formed by the fixing device and thus at the front of the vehicle, this fixing section can be used in a particularly user-friendly manner to achieve the fixing state. This is because a user can easily and visually arrange the vehicle at the fixing section formed by the station by means of the fixing section provided on the vehicle by moving the vehicle in the direction of travel. In addition, this allows the fixing section to be provided in a spatially particularly advantageous position on the vehicle. The front of the vehicle is, of course, understood to be the side towards which the vehicle faces when traveling straight ahead as intended, i.e. the side that is visible when viewing the vehicle purely from the front.

In one embodiment, the vehicle has at least one front wheel and at least one rear wheel as well as a basic structure. The basic structure comprises a frame with a steering tube, a steering rod, and a handlebar. The front wheel and the rear wheel are connected to each other by means of the frame. The steering rod is rotatably mounted in the steering tube. The handlebar is firmly connected to the steering rod. The axles around which the wheels are rotatably mounted are provided on the frame or on the steering rod. In general, the first and second fixing sections of the fixing device and thus of the vehicle are preferably designed as projections protruding from the basic structure. The fixing section thus forms a projection formed by the basic structure. This allows the fixing section to be particularly robust and easily accessible. It is particularly preferred that the basic structure is made at least partially of metal, wherein the fixing section provided by the fixing device is made of metal. In general, the fixing section formed by the fixing device is preferably arranged on the steering bar or the steering tube of the vehicle. The arrangement on the steering tube has proven to be particularly advantageous, since the steering tube is rigidly connected to the frame of the basic structure and thus enables particularly rigid fixing of the vehicle to the station by means of the fixing section. In general, as explained, the vehicle preferably has at least one front wheel, at least one rear wheel, and a basic structure comprising a frame with a steering tube, a steering bar, and a handlebar, wherein the first and second fixing sections formed by the fixing device are arranged on the steering bar or the steering tube of the vehicle. It is also preferred that the charging port is arranged on the handlebar or the steering tube.

In one embodiment, the charging port is spaced apart from that fixing section which is comprised by the fixing device by less than 20 cm, in particular by less than 15 cm, in particular by less than 10 cm. This allows the charging port to be aligned with the charging device with particular positional accuracy by fixing the aforementioned fixing section relative to the fixing section comprised by the station. In general, it is preferred that the charging port be provided on the same side of the vehicle as the fixing section comprised by the fixing device. This is particularly advantageous for aligning the charging port relative to the charging device by means of the fixing section.

In one embodiment, the second fixing section is designed in the form of a ring or bracket which surrounds the first fixing section at least partially around an axis. In the case of a ring, this axis is the ring axis, and in the case of a bracket, this axis is the axis around which the bracket extends in sections. The bracket preferably extends around the axis by at least 180°, in particular at least 200°, and in particular at least 230°. The ring or bracket preferably forms the aforementioned receptacle by enclosing the axis at least in sections. The inventors have recognized that the design of the second fixing section in the form of a ring or bracket is particularly simple and that the introduction of the bolt into a ring or bracket and thus along the described axis in such a way that the bolt axis extends at least substantially parallel to the aforementioned axis makes it particularly easy to achieve reliable fixing of a vehicle at a station in the fixing state. The axis runs horizontally in a particularly preferred embodiment. It should be noted at this point that the vertical or vertical direction defines the direction in relation to which the wheels of the vehicle form the vertical underside of the vehicle with which the vehicle rolls on a road as intended. The vertical or vertical direction is thus the direction which, when the vehicle is used as intended on a level road, runs parallel to the force of gravity acting on the earth. The axis preferably runs horizontally and thus perpendicular to the aforementioned vertical or vertical direction. The horizontal alignment of the axis makes it particularly advantageous to define a vertical position of the fixing sections relative to each other by enclosing the first fixing section with the second fixing section. When providing a bracket as a second fixing section, it may be sufficient for the bracket to merely limit the first fixing section at its vertical upper side in the fixing state, since the vehicle in the fixing state in any case rests with its wheels and thus its vertical underside on a floor on which the station is mounted or which the station itself forms, so that the position range over which the fixing device and fixing means and thus the first and second fixing sections can move relative to each other along the vertical direction is sufficiently limited simply by enclosing the first fixing section at its vertical upper side. It is particularly preferred that the second fixing section, which is designed in the manner of a ring or bracket, also extends on at least one horizontal side of the first fixing section so that it limits the movement of the first fixing section along a horizontal direction in one direction. Preferably, the second fixing section surrounds the first fixing section at both ends with respect to this specific horizontal direction. Preferably, that one of the fixing device and fixing means which is comprised by the first fixing section has a recess in which the second fixing section is arranged in the fixing state and which is arranged on both sides of the second fixing section with respect to the aforementioned axis. The arrangement of the second fixing section in this recess therefore also limits the movement of the fixing device and the fixing means relative to each other along the aforementioned axis, so that the position range of the fixing device and the fixing means over which the relative position of the fixing device and the fixing means can vary is also defined with respect to the horizontal spatial direction corresponding to this axis. The arrangement of the first fixing section in the second fixing section particularly favors limiting relative movement of the fixing device and the fixing means in two mutually perpendicular spatial directions that are each perpendicular to the axis, whereas the relative movement of the fixing device and the fixing means along the said axis is limited by the arrangement of the second fixing section in the said recess, the position range to which the relative movement along the axis is limited being larger than the position range to which the relative movement in at least one of the said spatial directions perpendicular to the axis is limited, in particular larger than the two position ranges to which the relative movement along the two spatial directions perpendicular to the said axis is limited in each case. This ensures that the charging port and the charging device can be positioned as accurately as possible relative to each other in order to carry out the charging process, due to the fixed position of the fixing device and fixing means relative to each other, while at the same time allowing a vehicle to be connected to the station as easily as possible.

It is generally preferred for the fixing device to comprise the second fixing section. This means that the vehicle comprises the second fixing section, whereas the station comprises the first fixing section and the locking device. This allows the design of the vehicle to be kept as simple as possible. In general, it is preferred for the system, in particular the station, to comprise a control device for controlling the locking device, in which case the control device defines the time at which and the manner in which the locking device moves the first fixing section to selectively achieve the release state and the fixing state, depending on the setting of the control device and resulting from the movement of the first fixing section. In general, it is preferred that the second fixing section is permanently fixed in position on the vehicle. Particularly preferably, the second fixing section is provided on the basic structure of the vehicle, in particular on the frame, in particular on the steering tube. The permanent positional fixing of the second fixing section on the vehicle ensures that the second fixing section can be removed from the rest of the vehicle only through destruction or by means of a special tool not available to normal users.

In one embodiment, the fixing means comprises a track holder for fixing a position of at least one of the wheels of the vehicle with regard to a direction along the wheel axis of the respective wheel relative to the station in the fixing state. The track holder can be formed, for example, by a U-shaped rail that is designed to accommodate one or all wheels of the vehicle. In one embodiment, the track holder comprises two rails which are spaced from each other with reference to the direction along the wheel axis, wherein the wheel is arranged between the rails in the fixing state. In any case, the track holder is designed to limit a wheel movement along the wheel axis in the fixing state. Accordingly, the track holder contributes to the alignment of the vehicle and thus to the alignment of the charging port relative to the station in the fixing state. Therefore, generally preferably, the track holder comprises two sidewalls between which at least one of the wheels of the vehicle is arranged in the fixing state and which thus limit the mobility of this wheel along its wheel axis. In one embodiment, at least one of the wheels forms at least one section of the fixing device, so that the track holder and said at least one wheel of the vehicle contribute to defining the fixing device and the fixing means to each other to a position range in the fixing state, as described above. In another embodiment, the fixing device is formed exclusively by the basic structure of the vehicle and thus not by the wheels of the vehicle. In one embodiment, the track holder has two side walls, wherein at least one of the side walls has a restoring device and, on its side facing the other side wall, has a wall section which is connected to the restoring device and which, starting from the rest position, can be moved away from the other side wall against a restoring force provided by the restoring device, thereby increasing the distance between the side walls. In this embodiment, the distance between the side walls in the fixing state along the wheel axis of the wheel arranged between them is therefore variable. This means that the distance can be adjusted to different wheel widths or different track widths. The distance between the side walls is defined by the distance between the wall section of the said side wall and the other side wall. Preferably, both side walls each have such a wall section and such a restoring device that the distance between the side walls is determined by the distance between their wall sections. Due to the provision of the restoring device, it can always be ensured that a force is required to increase the distance between the side walls from the rest position, so that the restoring device acts to guide a wheel arranged between the side walls. Particularly preferably, the restoring device is designed as a spring device. In one embodiment, the restoring device is designed as a spiral and/or leaf spring device and the wall section is formed by a sheet metal plate which is supported by such a spring device relative to a fixed support. In one embodiment, the wall section is rotatably mounted on a fixed support via a pivot axis, wherein rotation of the wall section to increase its distance from the other side wall requires the application of a force. In this case, the wall section may be subjected to a restoring force purely due to a weight force and/or due to a spring force. In general, it is preferred that the side wall comprising the wall section has a support whose position is fixed, the wall section being movable relative to this support by overcoming the restoring force. In general, the restoring device is designed such that, when the wall section is deflected from its rest position, it acts to restore the wall section to its rest position.

In one embodiment, the charging device and at least that one of the first and second fixing sections which is comprised by the fixing means, are arranged together in a housing part of the station. The housing part forms an interior space in which the charging device and said fixing section are arranged. The housing part may be box-shaped, for example. The arrangement of the charging device and the said fixing section in the one housing part of the station may particularly favor a particularly good alignment of the charging port with the charging device in the fixing state. It is also particularly preferred that the locking device of the station is arranged in the housing part of the station. It is also particularly preferred that a control device of the station is arranged in the housing part of the station. In general, the station has a body by means of which it can be set up on a floor and mounted there. The body can, for example, be formed by a frame structure or a plate structure. It is particularly preferred that the housing part is fixed in position on the body of the station. It is particularly preferred that the body of the station is manufactured separately from the housing part of the station, but is permanently connected to the housing part of the station and thus securely fixed to it. This means that when the station is used in a public space, the housing part cannot be removed from the body of the station by a member of the public without destruction. In one embodiment, the charging port and at least that fixing section which is comprised by the fixing device are integrated together in a unit of the vehicle. For example, the vehicle may have a housing part in which the charging port and the said fixing section are arranged. Preferably, the charging port and the entire fixing device are integrated together in the aforementioned unit of the vehicle. In general, it is preferred that the unit of the vehicle is designed as an adapter manufactured separately from the rest of the vehicle and mounted on said rest of the vehicle. In general, it is preferred that the aforementioned unit is designed as an adapter mounted on the basic structure of the vehicle, in particular on the steering tube or on the steering rod of the vehicle. The adapter can be retrofitted to the basic structure or the rest of the vehicle after they have been manufactured. It is particularly preferred that the adapter can be mounted in a detachable manner, in which case it is preferably only possible to detach the adapter using special tools, i.e. not with standard tools. By integrating the charging port and the aforementioned fixing section into the unit, the system can be designed to be open for a wide range of different vehicles, in which case the vehicles can be provided by different vehicle fleet providers. This enables for example an organization such as a city administration to set up stations for the system in its area and require every vehicle fleet provider that wishes to offer vehicles for use in the organization's territory to equip its vehicles with such an adapter so that they are designed as part of the system and thus as vehicles of the system and operate accordingly as part of the system. The particularly preferred embodiment can thus make a particularly advantageous contribution to ensuring an appropriate distribution and maintaining a desired order in the territory of such an organization. The unit particularly preferably has a location module, for example a GPS module, GLONASS or GALILEO module. Such a location module is designed to determine the location data of the vehicle. Since the unit, which is preferably designed as an adapter as exaplained, itself has such a location module, the movement of the vehicle can be tracked via the unit itself and thus independently of other components of the vehicle. This allows the movement of the vehicle to be tracked purely on a vehicle-related basis, independently of user data, from which conclusions can be drawn about the expedient distribution of vehicles and typical, anonymized user routes. It is particularly preferred that the vehicle has, in addition to the location module comprised by the unit, a further location module which is designed to detect and output location data of the vehicle and via which, for example, a vehicle fleet provider can monitor the vehicle or its use. It is particularly preferred that the unit or adapter has a memory for storing a location history of the vehicle. Particularly preferably, the unit or adapter has a wireless interface via which the location data can be read wirelessly. It is generally preferred for the memory to be readable, in particular via the wireless interface. By providing such a memory and/or such a wireless interface, the aforementioned location data and thus movement data can be obtained from the unit itself. Particularly preferably, the unit is designed to store the location data in the memory depending on time and/or output it to the wireless interface, so that a time-dependent movement history of the vehicle can be obtained by means of the unit and read out from it either by reading out the memory or by directly reading out the wireless interface. This can enable an organization or an operator employed by the organization to obtain data from which expedient distributions of stations of the system at defined locations and/or an expedient distribution of vehicles of the system at defined locations, in particular a time-dependent distribution of the vehicles of the system at specific locations, can be determined. By designing such a unit as an adapter, such an organization or an operator employed by it can track all vehicles in the system, even if they are provided by different fleet providers, with their location history independently of any user data of the vehicle users and obtain data that is useful for the efficient operation of the entire system, where for example the location-and time-dependent provision of vehicles across the entire area, i.e. across the entire territory for which the respective organization is responsible, is determined on the basis of this data, i.e. the locations at which a certain number of vehicles in the system are to be made available to users are determined on a time-dependent basis, i.e. at certain stations of the system in a fixing state, in which case each of the specified stations is assigned a specific location. A location can be uniquely identified by GPS coordinates, for example.

In one embodiment, the charging device comprises a primary coil with a primary coil axis, and the charging port comprises a secondary coil with a secondary coil axis. The secondary coil axis is thus the coil axis assigned to the secondary coil, and the primary coil axis is the coil axis assigned to the primary coil. Particularly preferably, by the interlocking of the fixing device and the fixing means in the fixing state, an angled formed by the primary coil axis and the secondary coil axis is fixed to less than 30°, in particular to less than 20°, in particular to less than 10°. This means that the efficiency of charging the vehicle's battery in the fixing state can be particularly high due to the interaction of the charging device and the charging port. In the fixing state, the primary coil axis and the secondary coil axis are preferably fixed by the interlocking of the fixing device and the fixing means in an alignment in which they form an angle of more than 45°, in particular more than 60°, and in particular more than 70° with the vertical. This can be particularly advantageous for increasing the efficiency when charging the battery. In particular, such an alignment can advantageously prevent dirt from accumulating over the entire surface of the primary and secondary coils on the charging port or charging device. Preventing such dirt accumulation can improve efficiency. In embodiments in which the primary coil axis does not run perpendicular to the vertical and thus the coil cross-section of the primary coil does not point in the vertical direction, i.e. does not run perpendicular to the vertical direction, it is particularly preferred that the primary coil with its coil cross-section points downwards on its side facing the charging port in the fixing state.

In one embodiment, the primary coil and the secondary coil each have a coil cross-section perpendicular to their coil axis, wherein over the entire position range over which the relative position of the fixing device and the fixing means to each other is defined in the fixing state, at least 50%, in particular at least 60%, in particular at least 70%, in particular at least 80% of the coil cross-section of a first of the primary and secondary coils, whose coil cross-section is smaller than or equal to the coil cross-section of a second of the primary and secondary coils, is completely overlapped by the coil cross-section of the second of the primary and secondary coils. It should be noted at this point that the overlap of the coil cross-sections of the primary and secondary coils is particularly advantageous for achieving a high degree of efficiency. The primary and secondary coils may have the same coil cross-section or may differ in their coil cross-sections.

The inventors have recognized that it is particularly advantageous that, in the fixing state, it is ensured that the coil cross-sections overlap as far as possible, in which case, when providing two coil cross-sections of equal size for the primary and secondary coils, a first of these coils is preferably overlapped, as explained, by at least 50% with the coil cross-section of a second of the primary and secondary coils, wherein, when two different coil cross-sections are provided, it is preferably provided that at least the coil cross-section of one of the primary and secondary coils, which is smaller than the coil cross-section of the other of the primary and secondary coils, overlaps as much as possible with the coil cross-section of the other of the primary and secondary coils.

In one embodiment, the interlocking of the fixing device and the fixing means in the fixing state fixes the position of the charging port to the charging device in such a position range that charging of the battery with at least 70%, in particular at least 80%, in particular at least 90% of a maximum charging power, which indicates the maximum charging power that can be transmitted from the charging device to the battery via the charging connection, is ensured. The maximum charging power can be achieved if the charging port is positioned as expediently as possible relative to the charging device in order to optimize efficiency. Such absolutely optimized positioning cannot be completely ensured by the system according to the invention in the fixing state. However, the inventors have recognized that it is preferable to design the fixing device and the fixing means to correspond to each other in such a way that, in the fixing state, they fix the charging device and the charging port to each other in such a position range that charging of the battery over the entire possible position range is ensured with high efficiency. As explained, various measures can be taken to keep the efficiency as high as possible across the position range, for example by designing the fixing device and fixing means as complex as possible or by designing the primary and secondary coils to be as large as possible. The inventors have recognized that by defining a certain position range, it is possible to manufacture the system inexpensively and make it easy for a user to handle, in particular to easily achieve the fixing state, if the efficiency is allowed to vary to a certain extent over the defined position range but remains above a certain minimum value. This ensures energy-saving and therefore inexpensive charging of the battery by the station, while at the same time keeping manufacturing costs low and ensuring ease of use. The system is particularly preferred in that, due to the interlocking of the fixing device and the fixing means in the fixed position, the position of the charging port relative to the charging device is fixed in a position range in which, depending on the position within the position range, charging of the battery can be at least between 85% and 100%, in particular between 80% and 100%, of the total maximum charging power, whereby it is ensured across the position range that charging of the battery with at least 70% of the maximum charging power is achieved.

In one embodiment, the station comprises several charging devices and several fixing means, and the system comprises several vehicles, each of which has a fixing device assigned to it, a battery assigned to it, a charging port assigned to it, and several wheels assigned to it. The components of the respective vehicle may have properties which are explained here with reference to a vehicle of the system. Preferably, the fixing device of each vehicle of the system is designed to correspond to each fixing means of the system, and the charging port of each vehicle of the system is designed to correspond to each charging device of the system. Thus, each of the vehicles of the system can be designed as the one vehicle referred to in the present description of various embodiments of the invention, which can be parked at a specific station of the system and can be fixed at the station, thereby achieving the fixing state of the system. In one embodiment, in the fixing state, all vehicles of the system are fixed in position at one of their assigned fixing means of the system. Preferably, in the fixing state of the system, the vehicles of a selected group of vehicles of the system are parked at a station of the system and fixed in position there, as explained here in connection with various embodiments of the invention with reference to a vehicle. In one embodiment, the system comprises several vehicles, wherein in the fixing state, each of these several vehicles is fixed in position at one of the fixing means of a specific station of the system and the vehicles are held side by side at this station, wherein two adjacent vehicles are held at the station offset from each other along their direction of travel. The vehicles are arranged side by side with respect to a direction perpendicular to their respective direction of travel, but offset from each other along their direction of travel. This has the particular advantage that the vehicles can be held at the one station in a particularly space-saving manner, since components of the vehicles that protrude laterally, such as their handlebars, can be arranged offset from each other. In addition to the multiple vehicles and multiple fixing means mentioned above, the system particularly preferably has a group of further vehicles and a group of further fixing means. This group of further fixing means and further vehicles can, of course, be designed as generally explained for the fixing means or vehicles of the system. In a particularly advantageous embodiment, in the fixing state, not only is each of the multiple vehicles fixed in position to one of the multiple fixing means of the station, but each of the additional vehicles, i.e. the group of additional vehicles, is also fixed in position to one of the additional fixing means, i.e. the group of additional fixing means, in which case the additional vehicles are held side by side at the station as explained above with regard to the multiple vehicles, wherein two adjacent of the additional vehicles are held at the station offset from each other along their direction of travel, as explained above with regard to the multiple vehicles. It is particularly preferred that each of the additional vehicles forms a pair of vehicles together with one of the above-mentioned multiple vehicles, with the front ends of the vehicles facing each other, wherein, in particular, the fixing means of the station, at which they are held in a fixed position in the fixing state, are arranged at least in sections between the two vehicles of the pair, in particular between their front ends facing each other. The system can thus comprise a first group of vehicles and a second group of vehicles, as well as a first group of fixing means and a second group of fixing means. Each group of vehicles is arranged next to each other, with the vehicles of the different groups facing each other with their front ends. The multiple vehicles form the first group, the other vehicles form the second group of vehicles at the stations, and the other fixing means form the second group of fixing means of the system. By providing two such groups or by designing the station accordingly, a particularly large variety of vehicles can be kept at the station in a particularly space-saving manner. It is particularly preferred for the station to have a body that has a zigzag-like course, wherein in the fixing state, the multiple vehicles, i.e. the first group of vehicles, are arranged on one side of the zigzag-like course and the other vehicles, i.e. the second group of vehicles, are arranged on the other side of the zigzag-like course, so that the zigzag-like course runs between a first group of vehicles formed by the multiple vehicles and a second group of vehicles formed by the additional vehicles. The vehicles of the respective group are thus arranged next to each other along the extension of the body, with the body extending between the two groups of vehicles so that a group of vehicles is arranged on both sides of the body, with their front ends then facing each other. This ensures a particularly space-saving and cost-effective arrangement and storage of the vehicles of the system.

In one embodiment, the system has a load management device, wherein the load management device is designed to determine, in a charging state in which the system is in the fixing state and a plurality of vehicles fixed at the station are coupled with their respective charging ports to one of the charging devices for receiving charging power, the charging power output by the respective charging devices to their respective charging ports depending on a charging power state of the station which describes a charging characteristic of the station as a whole. Preferably, the station at which the plurality of vehicles is provided has the load management device. In the charging state, each vehicle is assigned one of the charging devices of the station and thus each charging port is assigned one of the charging devices. In the charging state, each charging port is coupled to the assigned charging device in such a way that the battery of the vehicle having the charging port can be charged. The higher-level load management device can be used to determine and thus control the output of the charging power depending on the charging power status of the station. The charging power status describes at least one charging characteristic of the station, for example a specified total charging power, a total charging current, and/or a total charging capacity of the station. Thus, it can be specified for example that the station only charges vehicles at the station with a maximum total charging power or a maximum total charging current, so that the charging power output at the respective charging port is determined depending on the total charging power or the total charging current, in order to avoid overloading of the station. The station particularly preferably has a station battery, in which case the charging power output at the charging ports is determined depending on the total charging capacity corresponding to the state of charge of the station battery. For example, the dependency of the output charging power can be determined taking into account a previously known, expected time-dependent progression of the total charging capacity. For example, a known point of time at which charging of the station battery is expected can be included in the dependency.

In one embodiment, the station has a station battery whose capacity is at least 10 times the capacity of the vehicle battery. If several vehicles are provided, the capacity of the station battery may be at least 10 times the capacity of the battery of each vehicle. The station battery is preferably at least 100 times, in particular at least 1000 times, the capacity of the vehicle battery. By providing such a station battery, the station can be particularly easy to use or set up, since no significant infrastructure needs to be provided at the location where the station is set up. This allows the station to be easily and, if necessary, installed also in a mobile manner at locations where little space is available but where it is needed, whereas, in contrast to the usual operation of battery-powered vehicles, where it is intended that the vehicles must be collected and charged individually, only the station battery needs to be charged at the station so that all vehicles can be charged. The station preferably weighs more than 100 kg, in particular more than 200 kg. This allows the station to be easily secured against vandalism and theft. It is particularly preferred that the station is designed to hold and charge the vehicle independently of a connection to an infrastructure when the system is in a fixing state and, in particular when the system is in a charging state, so that the station can charge the vehicles without being connected to a supply network. It is particularly preferred for the station to have a photovoltaic element for self-sufficient charging of its station battery. This keeps the energy and financial costs for charging the vehicles of the system as low as possible, since the station can charge its station battery itself via its photovoltaic element if possible, and additional charging by mobile personnel is only necessary if the photovoltaic element does not provide sufficient charge. It is particularly preferred that the station is connected to a central computing unit of the system via an interface, whereby the central computing unit monitors the total charging capacity of the station, i.e. the charge status of the station battery, with charging of stations being only carried out in a targeted manner depending on the total charging capacity, i.e. the charge status of the station battery.

In one embodiment, the system has at least a subset of vehicles, each of which is designed without a charging port but has a fixing device. The fixing device is designed to correspond to the fixing means of the station. Thus, each of the vehicles in the subset can be fixed in position as described above due to the corresponding design of the fixing device and the fixing means at the station. It is particularly preferred that the fixing section formed by the fixing device is formed by an adapter also in the subset of vehicles, which can be mounted on the rest of the vehicle as described above. In such a particularly advantageous embodiment of the system, vehicles can thus be specifically provided in the system which can be used by a user in a cost-effective manner, since the user only makes use of the fixability of his vehicle at the station, but not the charging option at the station. This can further improve the ecological and financial benefits of such a station.

In one embodiment, the system has a detection device for detecting the presence of the vehicle in such a position relative to the station in which the fixing state can be achieved solely by moving the first fixing section by means of the locking device. The system is thus designed to detect that the vehicle is positioned relative to the station in such a way that the system is in the release state and that the locking state can be achieved solely by moving the first fixing section by means of the locking device from the release state. The detection device may comprise, for example, an optical detection device such as a camera and/or a readout device such as the reading of a QR code located at a predefined position on the vehicle and/or a resistive or capacitive switch which detects the corresponding presence or position of the vehicle relative to the station. The detection device may additionally or instead be designed as a manual detection device, so that manual actuation of a portion of the detection device, for example a switch, lock or the like, enables the fixing state to be achieved and thus the vehicle to be locked at the station. However, particularly preferred, the detection device is an automatic detection device that automatically detects the presence of the vehicle or the aforementioned position of the vehicle without manual operation by a user. It is particularly preferred that the system has a control device that is designed to activate the locking device upon detection of the aforementioned position of the vehicle in order to achieve the fixing state. Particularly preferably, the system is designed to detect the aforementioned position of the vehicle automatically, i.e. without detection initiated by a user, via the detection device, and to automatically, i.e. without being consciously initiated by a user, actuate the locking device automatically after automatic detection of the position in order to achieve the fixing state. This ensures in a particularly simple and reliable manner that a vehicle is reliably held in place at the station as soon as a user brings it into the appropriate position at the station and, in particular, that it can be charged by the station.

In one embodiment, the system comprises an authentication device. The authentication device may be comprised by the detection device described above, or may comprise the detection device, or may be formed together with the detection device in a single unit. The authentication device and/or detection device are preferably comprised by the station. The system is preferably designed to control the locking device for moving the first fixing section to achieve the release state from the fixing state only if authentication has been established beforehand by the authentication device. This effectively prevents the vehicle from being released from the station without authorization. The authentication device preferably has a wireless interface for wireless detection of authentication. Such a wireless interface can be, for example, a Bluetooth, WLAN, or NFC interface. For example, the wireless interface can enable authentication by means of a mobile terminal, in particular a smartphone, for example by direct coupling between the smartphone and the authentication device or by indirect coupling via an Internet connection established between the smartphone and the authentication device.

The detection device is preferably designed to detect authentication of a first type and authentication of a second type, in which case the system is designed, when the first type of authentication is detected, to activate the locking device to achieve the fixing state and to prevent the charging device from supplying charging power, and when the second type of authentication is detected, to activate the locking device to achieve the fixing state and to control the charging device to supply charging power. According to this particularly preferred embodiment, the system can thus distinguish between two different types of authentication: a user who only has the first type of authentication can only park and lock his/her vehicle at the station, whereas a user who has the second type of authentication can also have his/her vehicle charged at the station while it is in the fixing state. Such an embodiment has the particular advantage that a wide range of functions can be provided with only one technical station. With only one station, both an operator of a fleet of vehicles registered at this station and an operator of a fleet of vehicles not registered at this station or a private individual can use the station. This means that the station can be set up in a public space, for example in large numbers in a large city, saving costs, materials, and space. It is particularly preferred that the system comprises, in addition to the detection device described above, the authentication device described above, wherein, starting from the fixing state of the system, upon detection of a first type of authentication or a second type of authentication, or upon detection of a third type of authentication, which is only authorized to remove the vehicle from the station, the locking device for moving the first fixing section is controlled to achieve the release state of the vehicle from the fixing state.

In one embodiment, the system comprises a plurality of stations, a plurality of vehicles, and a central computing unit. The vehicles each have a communication interface for wireless communication with a mobile terminal. The communication interface is preferably designed as a Bluetooth, WLAN, and/or NFC interface. Communication with the mobile terminal can take place directly with the mobile terminal or indirectly, with the mobile terminal and the communication interface each being connected to the Internet and communicating with each other via the Internet. The communication interface can be formed by the wireless interface of the authentication device described above or can be provided in addition to this. The mobile terminal can be a smartphone, tablet, or similar device, for example. Each of the vehicles also has a disable device. The disable device can be switched to a disable state and, as an alternative to the disable state, to an enable state. In the disable state, use of the vehicle's electric motor to operate the battery-powered vehicle as intended is prevented. In the enable state, intended use of the vehicle and thus use of its electric motor, which is powered by the battery, is enabled. Via the communication interface, the disable device can be switched to the disable state and, alternatively, to the enable state by means of the mobile terminal, independently of the position of the respective vehicle relative to the station. The disable device can thus be switched to the disable state or the enable state both when the vehicle is positioned at the station and when the vehicle is positioned remote from the station. The computing unit is preferably designed to determine the location of each vehicle and to assign one of the stations to the respective vehicle as the target station and to determine whether the respective vehicle is away from its assigned target station, in which case the computing unit is designed to whenever it has determined that the respective vehicle is away from the target station and has determined an identification of the mobile terminal and a travel command assigned to the identification with reference to the respective vehicle, and has subsequently determined a positioning of the vehicle at the target station, to credit a user account assigned to the identification. Preferably, the driving command causes the disable device, after previously being in the disable state, to be switched to the enable state. The identification may be, for example, the authentication described above. Each identification of a mobile terminal is assigned to a specific user account. Identification is therefore only possible if a corresponding user account has been created and assigned to the mobile terminal. The user account is thus referenced on the computing unit. It is particularly preferred that the respective vehicle is first remote from the target station while its disable device is in the disable state, whereupon the mobile terminal is identified, causing the disable device to assume the enable state, in which case the computing unit assigns a specific target station to the vehicle remote from the target station and only credits the user account if the computing unit determines that the vehicle that was first remote from the defined target station was positioned at the target station in response to a driving command assigned to the identification, which at least comprises changing the disable device from the disable state to the enable state, wherein it is preferably provided that the credit is only made to the user account if the computing unit determines that the respective vehicle is located at the designated station and its disable device is in the disable state and/or is fixed in position at the designated station by means of its fixing device and/or its battery is being charged by the charging device of the target station by means of its charging port. The particularly advantageous embodiment thus creates an incentive for a user, regardless of his/her desired use of the vehicle, to bring the vehicle to a target station if it is not located at such a station. In one embodiment, it is provided that such a credit is only made to the user account by the computing unit if the vehicle is first located remote from any station and is therefore not fixed in position at a station by means of its fixing device, wherein only on the basis of the driving command linked to the identification, the vehicle is brought to one of the stations and fixed in position at this station by means of its fixing device. In this case, any station of the system can be defined as the target station. In another embodiment, only a specific station of the system or a specific group of stations of the system is defined as a target station, so that the crediting or the incentive created thereby supports a targeted spatial distribution of the vehicles. It should be noted that each station can be assigned a location that can be uniquely identified, for example by means of GPS coordinates. By defining only a specific group of stations, preferably comprising only a single station, as the target station, a credit can only be issued if the vehicle that was initially located away from this station is brought to the location assigned to this station. This can have the particular advantage that any user who has a user account that is assigned to a corresponding identification can contribute to a desired spatial distribution of the vehicles in the system. The credit can, for example, be a credit on a user account, which the user can then invest in a use of the vehicle of his/her choice. In one embodiment, the credit can also be a monetary amount that is refunded to the user.

In one embodiment, the computing unit is designed to transmit information to the mobile terminal in response to a query assigned to the identification, which contains location data of at least one vehicle of this type that is positioned away from each of the stations or at least from a group of target stations and whose disable device is in the disable state. This allows a user who has a user account and thus an identification assigned to this user account to query the computing unit for specific location information on at least one vehicle that is located at least away from the group of target stations (which in any case comprises at least one station of the system), in particular from each of the stations, and whose disable device is in the disable state. The user can thus obtain specific information about a vehicle that is to be brought to a target station or at least to any station of the system. The user can thus earn credit by being directed to the corresponding vehicle through the location information and then bringing this vehicle to the target station and parking it there in its disable state.

In one embodiment, the computing unit is designed to dynamically select a specific group from the plurality of stations on the basis of a dependency stored in the computing unit and to transmit each station of the specific group as a target station to the mobile terminal. The computing unit is thus automatically able to identify specific stations of the system as target stations. This establishes a corresponding dependency in the computing unit. The computing unit can thus provide for the targeted distribution of vehicles to specifically selected stations. The dependency stored in the computing unit particularly prefers to take into account a frequency stored in the computing unit for the removal of vehicles previously fixed at the respective stations of the system from the stations. The computing unit is thus designed to register the removal of vehicles from the stations and to determine the dependency on the basis of which the respective target station or group of target stations is identified, depending on the determined frequency of vehicle removal at the respective station of the system. The computing unit is particularly preferably designed to automatically and dynamically determine the frequency stored from time-dependent location data determined from the vehicles of the system. The system can thus be designed to automatically determine the frequency by tracking the locations, in particular the time-dependent locations, of the vehicles of the system. The determination can always be dynamic, i.e. it can be changed dynamically by continuously determining the corresponding data over time. In one embodiment, the dependency stored in the computing unit comprises a time-of-day and location-dependent function stored in the computing unit, which defines the time-of-day and location-dependent frequency of vehicle use. This is based on the vehicle use at the respective station. By characterizing the vehicle use at the respective stations of the system with reference to its frequency, a group of stations, in particular exactly one of the stations, can be specifically identified as the target station. The time-of-day and location-dependent frequency of vehicle use can be determined, for example, by taking into account the frequency of vehicle use at the respective stations as determined by the station itself and/or by taking into account the expected frequency of use based on previously known events, such as the end of a concert or the end of a soccer game. Particularly preferably, the function includes usage information obtained independently by the system. Such usage information obtained independently by the system may, for example, include a specific event, i.e. its location and time with its effect on the expected frequency of vehicle use at the specific location at the specific time, wherein such an event may be, for example, the end of a concert or soccer game or, for example, the known location and time of rush hour traffic, which may be at least partly determined by a previously known close of business. In one embodiment, the amount of credit depends on the time of day and/or the location of the target station. This means that, in the event of a known, particularly high demand for vehicles at a specific location at a specific time, a particularly large incentive can be provided so that users bring the vehicles to a target station assigned to the respective location at the specified time of day in order to obtain the maximum possible credit. This can make a particularly valuable contribution to the environment, as the desired local and temporal distribution of vehicles can be achieved without the need for external transport measures and thus with the lowest possible energy consumption, which in turn enables the most environmentally friendly use by users who want to reach a specific location.

The invention also relates to a method for holding a battery-powered vehicle of a system according to the invention ready for use, which vehicle has a fixing device, a battery, a charging port, several wheels and, in particular, a track width of less than 50 cm, at a station of the system according to the invention comprising a fixing means corresponding to the fixing device for fixing the vehicle in a fixing state of the system, and an inductive charging device for inductively charging the battery in the fixing state by means of the charging port. At this point, it should be noted that the vehicle naturally has an electric motor that is designed to drive at least one of the wheels and is powered by the battery when the vehicle is used as intended. The battery-powered vehicle is therefore designed to be driven by an electric motor powered by the battery. According to a solution provided by the invention, a first fixing section designed as a movable bolt is inserted into a second fixing section designed as a receptacle for the first fixing section in order to securely fix the vehicle to the station. One of the first and second fixing sections is formed by the station and the other is formed by the vehicle. According to a further solution, in order to remove the vehicle from the station, which is securely fixed to the station by means of a first fixing section and a second fixing section engaging with one another, one of these fixing sections being formed by the station and the other by the vehicle, the first fixing section is removed from the second fixing section and the vehicle is then removed from the station. It is particularly preferred that, in order to release the vehicle from the station from its fixed position secured to the station, exclusively the first fixing section is removed from the second fixing section. It is particularly preferred that the vehicle is charged while it is securely fixed to the station and is held in its position relative to the station solely by the interaction of the fixing device and the fixing means. It is particularly preferred that the vehicle is brought from a state in which it is securely fixed at the station and is being charged into a state in which it can be freely removed from the station solely by moving the first and second fixing sections relative to each other. In the states mentioned, the fixing state or release state of the system described above can be achieved. In a particularly advantageous embodiment of the method according to the invention, the station automatically detects when the vehicle is in such a position relative to the station that it can be securely fixed there, whereupon, after such detection, the station automatically controls the locking device in such a way that the first fixing section is introduced into the second fixing section so that these two fixing sections engage with each other in such a way that the vehicle is held securely in position at the station. In a state in which the vehicle is held securely at the station, it is particularly preferred that the station automatically determines via the charging device whether charging of the vehicle battery via the charging port is possible and/or advantageous and, if so, that the station automatically charges the battery through the interaction of the charging device and the charging port while the vehicle is securely fixed at the station. It is particularly preferred that the station automatically interrupts a charging process that is carried out while the vehicle is securely fixed at the station as soon as the vehicle is released from the station. In one embodiment, a distinction is made between different types of authentication, wherein, upon detection of a first type of authentication, where a vehicle is merely fixed and secured at the station during parking the vehicle at the station, and only upon detection of a second type of authentication, but not upon detection of a first type of authentication, a vehicle is both securely fixed at the station and charged by the station when the vehicle is parked at the station.

The method according to the invention may comprise features which are explained here in connection with embodiments of the system according to the invention and/or in connection with generic systems or methods. The system according to the invention may comprise features which are described here in connection with embodiments of a method according to the invention and/or in connection with generic systems or methods. The embodiments described here can all be combined with each other in a particularly advantageous manner.

The invention is explained in more detail below with reference to eight drawing figures and embodiments.

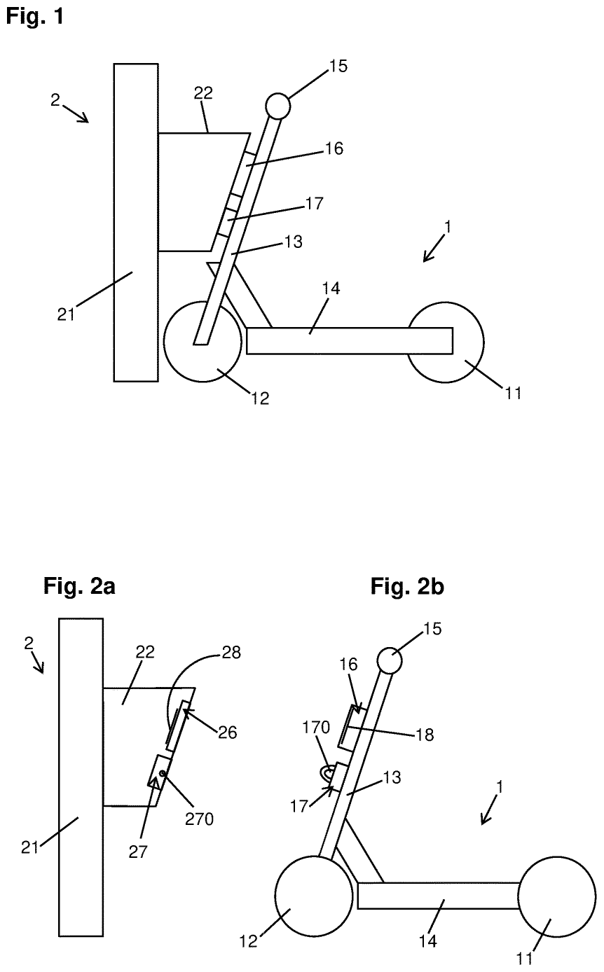

FIG. 1 shows a schematic diagram of an embodiment of a system according to the invention in its fixing state;

FIG. 2 shows various schematic diagrams of the station and the vehicle of the embodiment according to FIG. 1;

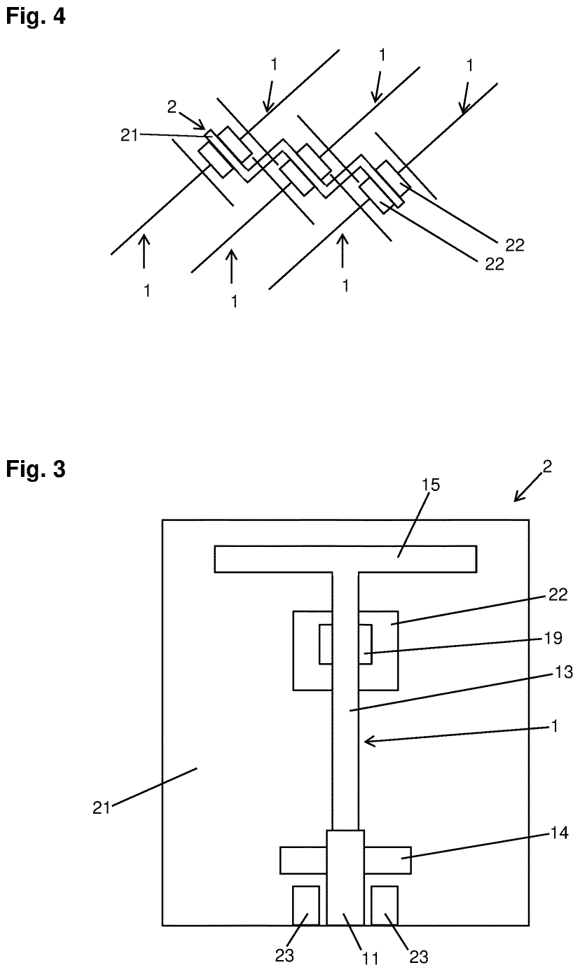

FIG. 3 shows a schematic diagram of a further embodiment of a system according to the invention in its fixing state;

FIG. 4 shows a schematic diagram of a further embodiment of a system according to the invention in its fixing state;

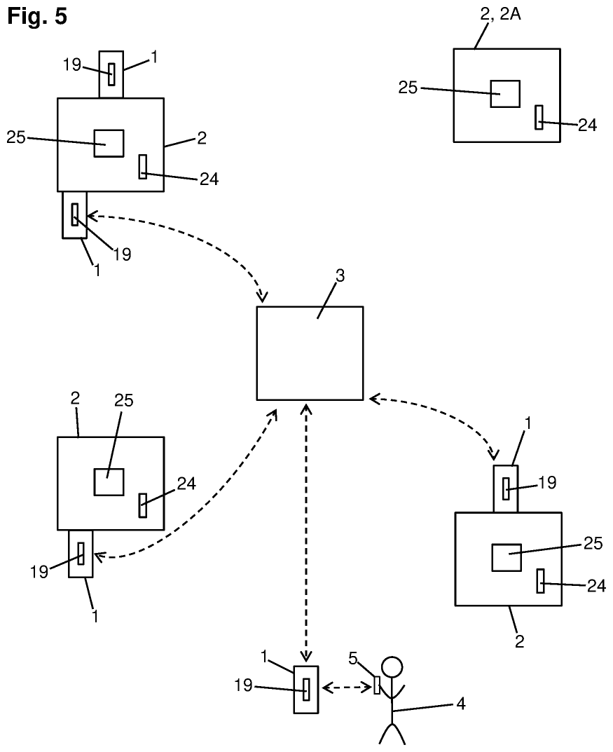

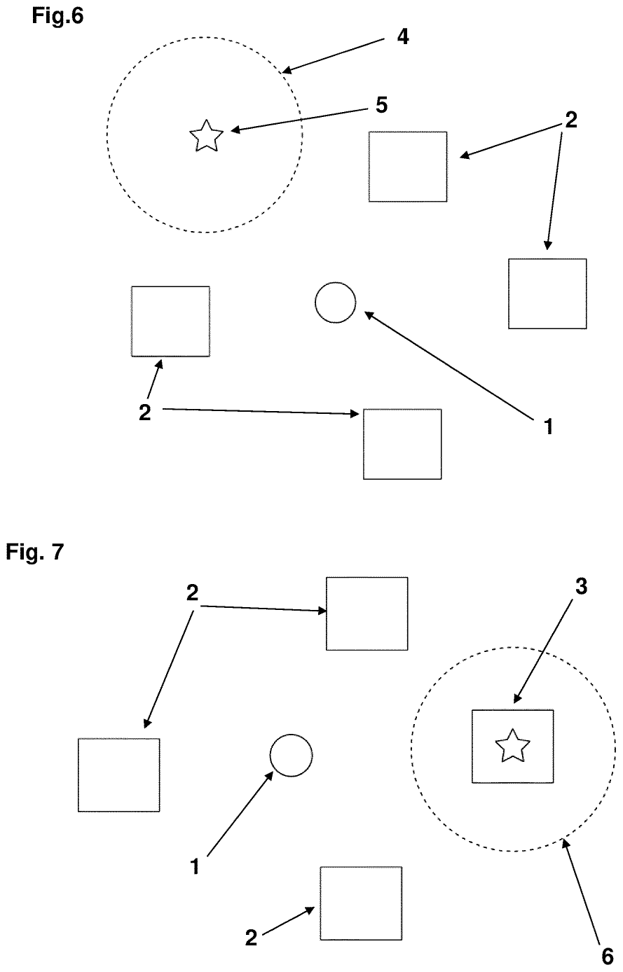

FIG. 5 shows a schematic diagram of a further embodiment of a system according to the invention;

FIG. 6 shows a schematic diagram of a further embodiment of a system according to the invention in an exemplary state, in a top view;

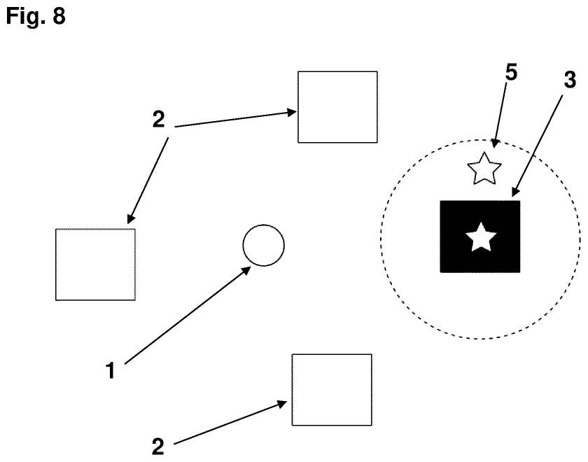

FIG. 7 shows a schematic diagram of a further embodiment of a system according to the invention in an exemplary state, in a top view;

FIG. 8 shows a schematic diagram of a further embodiment of a system according to the invention in an exemplary state, in a top view.

FIG. 1 shows an embodiment of a system according to the invention in its fixing state. The system comprises a station 2 with a body 21 and a housing part 22. The system further comprises a vehicle 1 with a front wheel 12 and a rear wheel 11, as well as a basic structure comprising a frame 14, via which the wheels 11, 12 are connected to each other, a steering tube 13, and a handlebar 15. The vehicle 1 further comprises a charging port 16 and a fixing device 17. In the fixing state shown in FIG. 1, the vehicle 1 stands with its wheels 11, 12 and the station 2 stands with its body 21 on a common floor. The vehicle 1 is securely fixed relative to the station 2 by the interaction of the fixing device 17 with a fixing means 27 of the station 2 shown in FIG. 2. The charging port 16 is positioned in a predefined position range relative to a charging device 26, as shown in FIG. 2, so that in the fixing state, a battery of the vehicle 1, not shown in FIG. 1, can be charged by the charging device 26 via the charging port 16. The charging device 26 and the fixing means 27 are both integrated into the housing part 22 that is attached to the body 21 of station 2.

In FIG. 2, which comprises FIGS. 2a and 2b, the station 2 and the vehicle 1 of the embodiment according to FIG. 1 are each shown in a sectional view. The section is taken along the vertical direction and along a horizontal direction perpendicular to the vertical direction. The horizontal direction corresponds to the direction in which the vehicle 1 moves when traveling straight ahead. The vertical direction corresponds to the direction along which the vehicle 1 rests with its wheels 11, 12 on a floor or road during normal use. FIG. 2a shows a section through the station 2. FIG. 2b shows a section through the vehicle 1. FIG. 2a shows that the charging device 26 and the fixing device 27 are arranged in the housing part 22 of the station 2. The charging device 26 forms a recess for the charging port 16. The charging device 26 comprises a primary coil 28, and the charging port 16 comprises a secondary coil 18. The fixing means 27 comprises a bolt 270, and the fixing device 17 comprises a bracket 170. The station 2 further comprises a locking device (not shown) which is designed to move the bolt 270 along its bolt axis. When the vehicle 1 approaches station 2 in such a way that the charging port 16 is located in the recess of the charging device 26 and the fixing device 17 is located with its bracket 170 in the recess formed by the fixing means 27, the bolt 270 can be inserted along its bolt axis into the receptacle enclosed by the bracket 170, whereby the vehicle 1 can be held in a fixed and secure position at the station 2. In this manner, the fixing state of the system is achieved. The relative position of the fixing means 27 and the fixing device 17 with respect to the vertical direction and the horizontal direction is determined by the arrangement of the bolt 270 in the receptacle formed by the bracket 170, whereas the relative position with respect to a further horizontal direction, which is perpendicular to the vertical direction and the said horizontal direction and corresponds to the bolt axis which surrounds the bracket 170, is determined by the arrangement of the fixing device 17 in the recess of the fixing means 27. In this fixing state, the primary coil 28 and the secondary coil 18 are essentially parallel to each other and overlap with their coil cross-sections essentially completely and are only very slightly spaced apart along their coil axes. Thus, the interlocking of the fixing device 17 and the fixing means 27 ensures that the vehicle 1 is positioned relative to the station 2 in the fixing state in such a way that the battery of the vehicle 1 can be charged with high efficiency by the charging device 26 via the charging port 16 by the interaction of the primary and secondary coils 28, 18.

FIG. 3 shows a further embodiment of a system according to the invention in its fixing state in a further, greatly simplified schematic representation. Components of the embodiment according to FIG. 3 which essentially correspond to the components of the embodiment according to FIGS. 1 and 2 are identified by the same reference signs. In the embodiment according to FIG. 3, the body 21 is plate-like. A track holder 23 is arranged on this body 21 and connected to it in a positionally fixed manner, which holder in the present case consists of two rails between which both the front wheel 12 and the rear wheel 11 of the vehicle 1 are arranged in the fixing state. Accordingly, the rails of the track holder 23 are spaced apart from each other with respect to a direction parallel to the wheel axes of the wheels 11, 12 so that the wheels 11, 12 can be arranged between them. It can be seen from FIG. 3 that the track holder contributes to positioning the vehicle 1 relative to the station 2. On the front side (not shown in FIG. 3) of the vehicle 1, a bracket 170 is provided as a second fixing section as in the embodiment shown in FIGS. 1 and 2, while on station 2 a bolt 270 is provided as a first fixing section, analogous to the embodiment according to FIGS. 1 and 2, so that the relative position of the vehicle 1 relative to station 2 is determined both by the interaction of the bolt 270 and the bracket 170 and by the interaction of the wheels 11, 12 with the track holder 23. The fixing section, which is formed by the fixing means, and the charging device are integrated in a housing part 22 of the station, and the fixing section, which is formed by the fixing device, and the charging port are integrated in a unit of the vehicle 1 designed as an adapter 19.

FIG. 4 shows a further embodiment of a system according to the invention in its fixing state in a greatly simplified schematic diagram. The system according to FIG. 4 comprises a plurality of vehicles 1, each of which is designed as an e-scooter. The system comprises a station 2 with a body 21 that extends in a zigzag-like course. A plurality of housing parts 22 are permanently mounted on the body 21. A first group of vehicles 1 is arranged on a first side of the body 21 and a second group of vehicles 1 is arranged on a second side of the body 21, wherein the vehicles 1 of each group are arranged next to each other and are held at the station 2 offset from each other along their direction of travel. As a result, their handlebars are also offset from each other along the direction of travel so that they can overlap perpendicular to the direction of travel. The vehicles of the two groups of vehicles 1 are arranged relative to each other in such a way that a vehicle 1 of the first group and a vehicle 1 of the second group form a pair of vehicles 1 with their front ends facing each other, wherein the fixing means of station 2, at which they are held in a fixed position in the fixing state, are arranged between them. The fixing means of station 2 are formed by the respective housing parts 22 of the station 2. FIG. 4 shows that the illustrated embodiment allows a very space-saving arrangement of a large number of vehicles 1 that can be fixed in position at the station 2 without interfering with each other.

FIG. 5 shows a further embodiment of a system according to the invention in a greatly simplified schematic representation. The system comprises several stations 2, each of which has a station battery 25 and a load management device 24. The system further comprises a central computing unit 3 and a plurality of vehicles 1. Each of the vehicles 1 has an adapter 19 with a wireless communication interface and a location module. The vehicles 1 communicate with the computing unit 3 of the system via the adapter 19. Each of the stations 2 has several fixing means and several charging devices, so that several vehicles 1 can be held in a fixed position at each of the stations 2, so that these vehicles are then fixed in position at station 2 and can be charged via their charging port by the charging device of station 2 assigned to them. The load management device 24 of the respective station specifies the charging power that is output via the respective charging devices of the station 2 to the respective charging port of the vehicle 1 assigned to the respective charging device. The load management device 24 thus enables each station 2 to control itself the charging power it supplies to its charging devices, taking into account the total charging capacity of its station battery 25. The computing unit 3 is designed to determine the location of each vehicle 1 via wireless communication with the adapter 19 of the vehicles 1. In the embodiment shown here, the computing unit 3 records a time-dependent frequency of removal of vehicles 1 fixed in position at the respective stations 2 of the system from the stations 2. Based on this frequency of removal of the vehicles 1 from the respective station 2 or of use of the vehicles 1 from the respective location at which the respective station 2 is located, which is determined by the computing unit 3 itself and stored in it, the computing unit 3 can contribute to an expedient spatial distribution of vehicles 1 and thus contribute to both ecological and financial added value through the spatial and time-dependent distribution of vehicles 1 at the stations 2 and by keeping the vehicles 1 in a charged state at the stations 2 in accordance with the time-dependent local distribution. This is because the determined frequency can be included into the first and/or second dependency function in such a way that the dependency function depends on the determined frequency, so that the computing unit 3 can specify a certain group of target stations, in particular exactly one target station, depending on the determined frequency of use and thus depending on a time-and location-dependent demand for vehicles 1, in which case a user receives a credit when he brings a vehicle 1 to one of the stations 2 of the group of target stations. For this purpose, in the embodiment shown here, the computing unit 3 is designed to detect the identification of a mobile terminal 5, in this case a smartphone, which a user 4 carries with him/her. When such identification is detected, which is assigned a user account assigned to the user 4, a disable device of a vehicle 1 is switched to an enable state so that the vehicle 1 can be used by the user 4 as intended using its electric motor, the computing unit 3 records the use of this vehicle 1 by the user 4 with his/her user account. The user 4, who is assigned to his/her identfication, can query the computing unit 3 for a target station 2A to which the vehicle 1 is to be brought. In the embodiment shown here, the vehicle 1, at which the user 4 identifies himself/herself with his mobile terminal 5, is not parked at any of the stations 2 of the system. In the embodiment shown here, the computing unit 3 provides the user 4 with information regarding the location details of a specific target station 2A. As soon as the computing unit 3 detects that the user 4 has brought the vehicle 1 to the target station 2A, so that it is parked at the target station 2A, and the vehicle 1 further transmits a corresponding message to the computing unit 3 indicating that vehicle 1 is ready for charging, i.e. is coupled with its charging port to a corresponding charging device at the station 2A, the computing unit 3 credits the user account of the user 4 to which the identification is assigned. This generally advantageous embodiment according to the invention ensures that, as a result of an incentive provided to the user 4, a spatially predetermined desired distribution of vehicles 1 at stations 2 and availability of vehicles 1 in a charged state at stations 2 can be ensured.

FIG. 6 shows a schematic representation of a system according to the invention, illustrating a spatial distribution of components of the system in a top view, with the system in an exemplary state. Four stations 2 are shown, which are spaced apart from each other. Furthermore, a target parking location 5 is shown with a first perimeter 4 surrounding this target parking location 5. A vehicle 1 is arranged between the stations 2 and the target parking location 5. In the illustrated state of the system, the vehicle 1 is not at a station and is in the disable state but not in the fixing state. According to the invention, it is generally preferred that the target parking location 5 can be determined depending on a local event taking place within the first perimeter 4 or at least in the vicinity of the perimeter 4, such as a soccer game, a music festival, or a public transportation failure. Furthermore, according to the invention, it is generally preferred that the target parking location 5 may also be defined depending on weather data and thus, for example, be selected in the vicinity of waters, beach, or similar. According to the invention, particularly preferably, the target parking location 5 may have been determined on the basis of a probable high demand for vehicles 1 in the first perimeter 4, e.g. using a computer model and/or an AI-generated prediction, e.g. based on historical data, in which case the definition of the perimeter may be formulated depending on this. The definition of the perimeter allows taking account of the fact that there may be a particularly high demand for vehicles at certain times and in certain locations, which demand should be met regardless of the availability of vacancies at stations.

FIGS. 7 and 8 show a schematic representation of a system according to the invention, illustrating a spatial distribution of components of the system in a top view, with the system in an exemplary state. Three stations 2 are shown, which are spaced apart from each other. A fourth station 2 is defined as the target station 3, and the second perimeter 6 runs around the center of the target station 3. A vehicle 1 is spatially arranged between the stations 2 and the target station 3. In the system state shown, vehicle 1 is not at a station and is in the disable state, but not in the fixing state. According to the invention, it is generally preferred that a station 2 can be defined as a target station 3, depending on whether there are fewer vehicles 1 at this target station 3 than at the other stations 2, or other stations 2 are already fully occupied with vehicles 1 and cannot accept any more vehicles, or an increased demand for vehicles 1 is expected at this target station 3 and/or in the vicinity of this target station 3, or an increased demand for vehicles 1 is requested by a user. In FIG. 8, the target station 3 is shown as unusable. According to the invention, a station 2 and/or a target station 3 can generally be defined as unusable if it is observed that the station 2 and/or target station 3 is completely occupied by vehicles and/or is defective. In this case, the perimeter definition, which is used to determine the perimeter for determining the target parking location, is made depending on these observations. Further according to the invention and generally preferred, a station 2 which has been identified as unusable can be defined as a target station 3, in which case a perimeter around the target station 3 can be defined as the target parking location 5.

### LIST OF REFERENCE SIGNS

1 vehicle
2 station
3 target station
4 first perimeter
5 target parking location
6 second perimeter
11 rear wheel
12 front wheel
13 steering tube
14 frame
15 handlebar
16 charging port
17 fixing device
18 secondary coil
19 adapter
21 body
22 housing part
23 track holder
24 load management device
25 station battery
26 charging device
27 fixing means
28 primary coil
170 bracket
270 bolt

1. A system comprising:
a battery-powered vehicle (1) which has a fixing device (17), a battery, a charging port (16) and several wheels (11, 12); and
several stations (2) for charging and holding the vehicle (1), wherein the stations (2) each comprises a fixing means (27) corresponding to the fixing device (17) for fixing the vehicle (1) in a fixing state of the system, and a charging device, so that the vehicle (1) can be brought into the fixing state at each station (2), wherein in the fixing state, the fixing means (27) of one of the stations (2) and the fixing device (17) engage with one another, preventing the vehicle (1) from being removed from the station (2),
wherein in a release state of the system, the fixing means (27) of the stations (2) and the fixing device (17) do not engage with each other, so that the vehicle (1) can be removed from the stations (2),
wherein the vehicle (1) comprises a drive and a communication interface, wherein in an enable state of the vehicle (1) the drive can be controlled and in a disable state of the vehicle control of the drive is prevented, and wherein switching is possible between the disable state and the enable state of the vehicle (1) both in the release state and the fixing state, wherein the system further comprises a computing device and a memory, wherein the computing device is designed to communicate with the communication interface of the vehicle (1) and the computing device is further designed to store a predefined value in a memory area of the memory upon detection of a transition of the vehicle (1) from the fixing state to a ready-to-drive state in which it has the release state and the enable state, and to convert this predefined value to a first modified value upon transition of the vehicle (1) from the ready-to-drive state to the disable state only and/or to convert the predefined value into a second modified value upon transition of the vehicle (1) from the ready-to-drive state to a state in which it has the disable state and, in addition, the fixing state, the system comprising a plurality of further vehicles,
wherein the computing device is designed to receive user data for using the vehicle (1), and wherein the computing device is designed to assign the first modified value to this user data in the memory area while storing a first credit balance information assigned to the user data in the memory, and the computing device is designed to assign the second modified value to this user data in the memory area while storing a second credit balance information assigned to the user data in the memory, wherein the computing device is configured, upon detection of a transition of the vehicle (1) from the ready-to-drive state to only the disable state, to assign credit information to a user account in the memory depending on the first credit balance information under modification of the first credit balance information, wherein the dependency of the credit information on the first credit balance information is determined by a first dependency function, wherein the computing device is configured, upon detection of a transition of the vehicle (1) from the ready-to-drive state to the state in which it has the fixing state and the disable state, to assign credit information to the user account in the memory depending on the second credit balance information under modification of the second credit balance information, wherein the dependency of the credit information on the second credit balance information is determined by a second dependency function, wherein the computing device is designed to define an area defined by a first perimeter (4) around a first geoposition as a target parking location (5), wherein the first perimeter (4) is defined by a first perimeter definition, and wherein the first dependency function includes, as a parameter influencing a value of the first dependency function, a query whether the transition from the ready-to-drive state to only the disable state has taken place at the target parking location (5).

2. The system according to claim 1, wherein the first perimeter definition is determined, in particular by the computing device, depending on a first predefined density of vehicles (1) in a predefined perimeter of the geoposition.

3. The system according to claim 1, wherein the first perimeter definition is determined depending on time data, position data, weather data, and/or the computing device is configured to determine the first perimeter definition depending on user input data received at the computing device.

4. The system according to claim 1, wherein the computing device is configured to define the station (2) or one of the multiple stations (2) located within a second perimeter (6) around a second geoposition as the target station (3), wherein the second perimeter (6) is defined by a second perimeter definition.

5. The system according to claim 4, wherein the second perimeter definition is determined, by the computing device, depending on a second predefined density of vehicles (1) in a predefined perimeter of the second geoposition.

6. The system according to claim 4, wherein the second dependency function includes, as a parameter influencing a value of the second dependency function, a query whether a detection of transition from the ready-to-drive state to the state in which it has the fixing state and the disable state has been made at the station (2) defined as the target station (3), and/or the second dependency function includes, as a parameter influencing a value of the second dependency function, the query whether detection of the transition from the ready-to-drive state to the disable state has been made in the predefined second perimeter (6) around the target station (3), and wherein the second dependency function depends on a detection of availability of the target station (3).

7. The system according to claim 4, wherein the second perimeter definition is determined depending on time data, position data, weather data, and/or the computing device is configured to determine the first perimeter definition depending on user input data received at the computing device.

8. The system according to claim 1, further comprising a plurality of vehicles (1) and a central computing unit (3), wherein the vehicles (1) each have a communication interface for wireless communication with a mobile terminal (5), and a disable device, wherein the disable device can be switched via the communication interface independently of a positioning of the respective vehicle (1) relative to the station (2) to a disable state and, as an alternative to the disable state, to an enable state, with the mobile terminal (5), wherein the computing unit (3) is designed to determine a location of each vehicle (1) and to assign the respective vehicle (1) one of the stations (2) as a target station (2A) and to determine whether the respective vehicle (1) is removed from the target station (2A) assigned to it, wherein the computing unit (3) is designed in such a way that whenever it has determined
i) that the respective vehicle (1) is removed from the target station (2A) and
ii) an identification of the mobile terminal (5) and a driving command assigned to the identification with reference to the respective vehicle (1) and
iii) subsequently a positioning of the vehicle (1) at the target station (2a), to assign credit information to a user account assigned to the identification.

9. The system according to claim 8, wherein the computing unit (3) is designed to transmit information to the mobile terminal (5) in response to a query assigned to the identification, which information contains location data of at least one vehicle (1) that is positioned remote from each of the stations (2) or at least from a group of target stations (2A) and whose disable device is in the disable state.

10. The system according to claim 8, wherein the computing unit (3) is configured to dynamically select a specific group from the plurality of stations (2) on a basis of a dependency stored in the computing unit (3) and to transmit each station of the specific group as a target station (2A) to the mobile terminal (5).

11. The system according to claim 10, wherein the dependency stored in the computing unit (3) takes into account a frequency stored in the computing unit (3) of a removal of vehicles (1) previously positionally fixed at the respective stations (2) of the system from the stations (2), wherein, in particular, the computing unit (3) is configured to automatically and dynamically determine the stored frequency from time-dependent location data determined from the vehicles (1) of the system.

12. The system according to claim 11, wherein the dependency stored in the computing unit (3) comprises a function stored in the computing unit (3) that is dependent on a time of day and location and defines the time of day and a location-dependent frequency of vehicle use, wherein the function comprises usage information obtained independently of the system.

13. The system according to claim 8, wherein the credit information depends in its amount on a time of day and/or on a location of the target station (2A).

14. The system according to claim 1, wherein the charging device is an inductive charging device for inductively charging the battery in the fixing state with the charging port (16), wherein one of the fixing device (17) and the fixing means (27) has a first fixing section including a movable bolt (270) and a locking device for moving the first fixing section, and the other of the fixing device (17) and the fixing means (27) has a second fixing section including a receptacle for the first fixing section, wherein in the fixing state, the first fixing section is arranged in the receptacle and is enclosed by the receptacle, preventing the first fixing section from being removed, wherein the first fixing section can be moved out of the receptacle with the locking device from the fixing state in order to achieve the release state of the system in which the vehicle (1) can be removed from the station (2), wherein the fixing device (17) and the charging device (26) are positioned relative to each other in a fixed manner and wherein the fixing device (17) and the charging port (16) are positioned relative to each other in a fixed manner.

15. The system according to claim 14, wherein the fixing device (17) and the fixing means (27) engage with each other in the fixing state with their relative position to each other is fixed in all three spatial directions to a position range of less than 5 cm in each case.

16. The system according to claim 14, wherein the one of the first or second fixing sections which is comprised by the fixing device (17) is on a front side of the vehicle (1).

17. The system according to claim 14, wherein the several wheels include at least one front wheel (12) and at least one rear wheel (11) and the vehicle (1) includes a basic structure comprising a frame (14) with a steering tube (13), a steering rod and a handlebar (15), wherein the front wheel (12) and the rear wheel (11) are connected via the frame (14), wherein the one of the first and second fixing sections which is comprised by the fixing device (17) is a projection protruding from the basic structure and/or is arranged on the steering rod or the steering tube (13) of the vehicle (1).

18. The system according to claim 14, wherein the charging port (16) is spaced from that fixing section which is comprised by the fixing device (17) by less than 20 cm and/or that the charging port (16) is on a same side of the vehicle (1) as the fixing section that is comprised by the fixing device (17).

19. The system according to claim 14, wherein the fixing device (17) comprises the second fixing section and the second fixing section is on the vehicle (1) in a permanently positionally fixed manner.

20. The system according to claim 14, wherein the fixing means (27) comprises a track holder (23) for fixing a position of at least one of the wheels (11, 12) of the vehicle (1) relative to a direction along its wheel axis relative to the station (2) in the fixing state.

21. The system according to claim 20, wherein the track holder has two side walls between which at least one of the wheels (11, 12) of the vehicle (1) is arranged in the fixing state, wherein at least one of the side walls has a restoring device and, on its side facing the other side wall, a wall section which is connected to the restoring device and which, starting from a rest position, can be moved away from the other side wall against a restoring force generated by the restoring device, thereby increasing a distance between the side walls.

22. The system according to claim 14, wherein the charging device (26) and at least the fixing section which is comprised by the fixing device (27) are arranged together in a housing part (22) of the station (2), wherein the locking device and/or a control device of the station are also arranged in said housing part (22),
and/or
the charging port and at least the fixing section which is formed by the fixing device (17) are integrated together in a unit of the vehicle (1), wherein the unit of the vehicle (1) is an adapter (19) manufactured separately from the rest of the vehicle (1) and mounted thereon.

23. The system according to claim 22, wherein the unit, in particular the adapter (19), comprises a location module for determining location data of the vehicle (1) and a memory for storing a location history of the vehicle (1), wherein said unit has a wireless interface via which the location data can be read out wirelessly.

24. The system according to claim 14, wherein the charging device (26) comprises a primary coil (28) with a primary coil axis and the charging port (16) comprises a secondary coil (18) with a secondary coil axis, wherein an interlocking of the fixing device (17) and fixing means (27) defines an angle formed by the primary coil axis and the secondary coil axis to less than 30° and/or in the fixing state, the primary coil axis and the secondary coil axis are fixed by said interlocking of the fixing device (17) and the fixing means (27) to an alignment in which they form an angle of more than 45° to the vertical.

25. The system according to claim 24, wherein the primary coil (28) and the secondary coil (18) each have a coil cross-section perpendicular to their respective coil axes, wherein over the entire position range to which the relative position of the fixing device (17) and fixing means (27) is fixed relative to each other in the fixing state, at least 50% of the coil cross-section of a first of the primary and secondary coils (28, 18), whose coil cross-section is smaller than or equal to the coil cross-section of a second of the primary and secondary coils (28, 18), is completely overlapped by the coil cross-section of the second of the primary and secondary coils (28, 18.

26. The system according to claim 14, wherein by an interlocking of the fixing device (17) and the fixing means (27) in the fixing state, a position of the charging port (16) relative to the charging device (26) is fixed in a position range such as to ensure the battery being charged with at least 70% of a maximum charging power that indicates a maximum chargeable power that can be transferred from the charging device (26) to the battery via the charging connection (16).

27. The system according to claim 14, wherein the station comprises several charging devices (26) and several fixing means (27) and the system comprises several vehicles (1), each of which has a fixing device (17) assigned to it, a battery assigned to it, a charging port (16) assigned to it and several wheels (11, 12),
wherein, in the fixing state, each of the vehicles (1) is fixed in position at one of the fixing means (27) and the vehicles (1) are held side by side at the station (2), wherein two adjacent vehicles (1) in each case are held at the station (2) offset from one another along their direction of travel, wherein the station (2) comprises a group of further fixing means (27) and the system comprises a group of further vehicles (1), each of which has a fixing means (27) assigned to it, a battery assigned to it, a charging port (16) assigned to it, and a plurality of wheels (11, 12) assigned to it, wherein in the fixing state, each of the vehicles (1) is fixed in position at one of the further fixing means (27) and the further vehicles (1) are held side by side at the station (2), wherein two adjacent of the further vehicles (1) in each case are held at the station (2) offset relative to each other along their direction of travel, and wherein one of the further vehicles (1) together with one of the plurality of vehicles (1) forms a pair of vehicles (1) which face each other with their front ends, wherein, in particular, the fixing means of the station (2), at which the vehicles of the pair are held in a fixed position in the fixing state, are arranged between the vehicles (1) of the pair, at least in sections.

28. The system according to claim 27, wherein the station (2) has a body (21) extending in a zigzag-like course, wherein in the fixing state, said multiple vehicles (1) are arranged on a first side of its course and said further vehicles (1) are arranged on a second side of its course, so that that the body with its zigzag-like course runs between a first group of vehicles (1) including said plurality of vehicles (1), and a second group of vehicles (1) including said further vehicles (1).

29. The system according to claim 27, further comprises a load management device (24), wherein the load management device (24) is configured in such a way that, in a charging state in which the system is in the fixing state and a plurality of the vehicles (1) fixed at the station (1) are connected with their respective charging ports (16) to one of the charging devices (26) for receiving a charging power, it determines the charging power output by the respective charging devices (26) to the charging port assigned to them in each case depending on a charging power state of the station (1) which describes a charging characteristic of the station as a whole including a total charging power, a total charging current and/or a total charging capacity of the station.

30. The system according to claim 14, wherein the station (2) comprises a station battery (25) whose capacity is at least 10 times that of the battery of the vehicle (1), wherein the station (1) has a weight of more than 100 kg and is configured to hold and charge the vehicle (1) independently of a connection to an infrastructure when the system is in a fixing state, wherein the station (1) has a photovoltaic element for self-sufficient charging of its station battery (25).

31. The system according to claim 24, further comprises at least a subset of vehicles (1), each of which is without a charging port (16), but each of which has a fixing device configured to correspond to the fixing means of the station (2) to enable releasable, position-fixed fixing of each vehicle (1) of the subset to the station (2).

32. The system according to claim 14, further comprises a detection device for detecting the presence of the vehicle (1) in such a position relative to the station that the fixing state can be achieved solely by moving the first fixing section with the locking device, and a control device which is designed to actuate the locking device to achieve the fixing state when this position is detected.

33. The system according to claim 14, wherein the station (2) further comprises an authentication device, wherein the system is configured to control the locking device for moving the first fixing section to achieve the release state only if authentication has been established beforehand by the authentication device, wherein the authentication device comprises a wireless interface for wireless detection of authentication.

34. The system according to claim 33, wherein the detection device is configured to detect authentication of a first type and authentication of a second type, wherein the system is designed to when authentication of the first type is detected, to actuate the locking device and prevent the charging device (26) from supplying charging power, and when authentication of the second type is detected, to actuate the locking device and control the charging device (26) to supply charging power.

35. A method for operating a system, the system including a battery-powered vehicle (1) with a fixing device (17), a battery, a charging port (16) and several wheels (11, 12); and several stations (2) for charging and holding the vehicle (1), wherein the stations (2) each include a fixing means (27) corresponding to the fixing device (17) for fixing the vehicle (1) in a fixing state of the system, and a charging device, so that the vehicle (1) can be brought into the fixing state at each station (2), the method comprising:
in the fixing state, the fixing means (27) and the fixing device (17) engage with one another, preventing removal of the vehicle (1) from the corresponding station (2),
in a release state of the system, the fixing means (27) and the fixing device (17) do not engage with each other, so that the vehicle (1) can be removed from the corresponding station (2), the vehicle (1) has a drive and a communication interface,
in an enable state of the vehicle (1) the drive can be controlled and in a disable state of the vehicle the control of the drive is prevented, and wherein the vehicle (1) can be switched between the disable state and the enable state both in the release state and the fixing state,
monitoring takes place as to whether the vehicle (1) transitions from the fixing state to a ready-to-drive state in which it has the release state and enable state and, upon detection of such a transition, a predefined value is stored and then monitoring takes place as to whether the vehicle (1) transitions from the ready-to-drive state to merely the disable state without also transitioning to the fixing state, or whether it transitions from the ready-to-drive state to both the disable state and the fixing state, wherein upon detection of a transition of the vehicle (1) from the ready-to-drive state to merely the disable state, the predefined value is converted to a first modified value and the predefined value is converted to a second modified value upon transition of the vehicle (1) from the ready-to-drive state to the disable state and the fixing state,
wherein the system includes a plurality of further vehicles which are monitored with regard to their state and their location, wherein user data is received for use in the vehicle (1) user data is received, wherein, depending on whether the predefined value has been converted into the first or second modified value, the first modified value is assigned to this user data storing a first credit information assigned to the user data or the second modified value is assigned to this user data storing a second credit information assigned to the user data, and wherein a computing device is configured to influence credit information by modifying the first and second credit information accordingly with a first dependency function and a second dependency function, wherein upon detection of a transition of the vehicle (1) from the ready-to-drive state to only the disable state, credit information is assigned to a user account depending on the first credit balance information, wherein the dependency of the credit information on the first credit balance information is determined by a first dependency function and wherein, upon detection of a transition of the vehicle (1) from the ready-to-drive state to the state in which it has the fixing state and the disable state, credit information is assigned to the user account depending on the second credit information, wherein the dependency of the credit information on the second credit balance information is determined by a second dependency information, wherein an area defined by the a first perimeter (4) around a first geoposition is defined as the a target parking location (5), wherein the first perimeter (4) is defined by a first perimeter definition, wherein the first dependency function includes, as a parameter influencing a value of the first dependency function, a query whether a detection of the transition from the ready-to-drive state to the disable state has occurred at the target parking location (5).

36. A method for keeping a battery-powered vehicle (1) according to a system of claim 1, which has the fixing device (17), the battery, a the charging port (16) and several wheels (11, 12), available at a station (2) of the system which comprises a fixing means (27) corresponding to the fixing device (17) for fixing the vehicle (1) in a fixing state of the system, and an inductive charging device (26) for inductively charging the battery in the fixing state with the charging port (16), the method comprising:
for secure fixing of the vehicle (1) at the station (2), a first fixing section including a movable bolt (270) is inserted into a second fixing section designed as a receptacle for the first fixing section, one of the first and second fixing sections being formed by the station (2) and the other of the first and second fixing sections being formed by the vehicle (1), and
for removing the vehicle (1) from the station (2) to which it is securely fixed, the first fixing section is removed from the second fixing section and then the vehicle (1) is removed from the station (2), wherein the vehicle (1) while it is securely fixed at the station (2) is charged and is held securely in its position relative to the station (2) solely by the an interaction of the fixing device (27) and the fixing device (17), wherein the vehicle (1), starting from a state in which it is securely fixed at the station (2) and is being charged, is brought into a state in which it can be freely removed from the station (2) solely by moving the first and second fixing sections relative to each other.
